(19) United States
(12) Patent Application Publication
(10) Pub. No.: US 2025/0184273 A1
(43) Pub. Date: Jun. 5, 2025

(54) SYSTEM AND METHOD FOR PACKET LOSS PREVENTION AMONG NETWORK GATEWAYS IN SOFTWARE DEFINED NETWORKS

(71) Applicant: NOKIA SOLUTIONS AND NETWORKS OY, Espoo (FI)

(72) Inventor: Shailesh PRABHU, Manipal (IN)

(21) Appl. No.: 18/528,366

(22) Filed: Dec. 4, 2023

(51) Int. Cl. H04L 47/125; H04L 47/10

(52) U.S. Cl. CPC H04L 47/125; H04L 47/29

(57) ABSTRACT

A packet loss prevention controller in a software defined network, including: at least one processor; and at least one memory storing instructions, that when executed by the at least one processor, cause the device at least to: collect first network gateway (NG) metrics for a first NG, wherein the first NG receives data packets from a network; analyze the first NG metrics to produce a plurality of first performance metrics; compare the plurality of first performance metrics to a plurality of performance thresholds; and activate a shunt link between the first NG and a second NG when one of the plurality of first performance metrics exceeds one of the plurality of performance thresholds, wherein the shunt link transmits data packets received by the first NG from the network to the second NG.

### FIELD OF THE DISCLOSURE

Various exemplary embodiments disclosed herein relate to system and method for packet loss prevention among network gateways in software defined networks.

### BACKGROUND

A Software Defined Network (SDN) includes several redundant last-mile Network Gateways (NG) on access sites, to which the users logically connect, in order to access various services offered by the network. Whenever connectivity to a primary NG goes down, the Mastership (authority) gets handed over to a secondary NG, which then takes over as a Master Gateway. However, during the course of this handover, some of the in-transit packets continue to reach the primary NG and get dropped due to the failure of primary NG.

### SUMMARY

A summary of various exemplary embodiments is presented below.

Various embodiments are described, packet loss prevention controller in a software defined network, including: at least one processor; and at least one memory storing instructions, that when executed by the at least one processor, cause the device at least to: collect first network gateway (NG) metrics for a first NG, wherein the first NG receives data packets from a network; analyze the first NG metrics to produce a plurality of first performance metrics; compare the plurality of first performance metrics to a plurality of performance thresholds; and activate a shunt link between the first NG and a second NG when one of the plurality of first performance metrics exceeds one of the plurality of performance thresholds, wherein the shunt link transmits data packets received by the first NG from the network to the second NG.

Various embodiments are described, wherein the plurality of first performance metrics includes at least a compute metric and the plurality of performance thresholds includes at least a compute threshold.

Various embodiments are described, wherein the plurality of first performance metrics includes at least a network metric and the plurality of performance thresholds includes at least a network threshold.

Various embodiments are described, wherein the plurality of first performance metrics includes at least a control channel flap frequency metric and the plurality of performance thresholds includes at least a control channel threshold.

Various embodiments are described, wherein the plurality of first performance metrics includes a compute metric, a network metric, and a control channel flap frequency, and the plurality of performance thresholds includes a compute threshold, network threshold, and a control channel threshold.

Various embodiments are described, wherein activating the shunt link includes installing a flow rule on the first NG.

Various embodiments are described, wherein the instructions further cause the device to: report a failure of the first NG to a SDN controller when one of the plurality of first performance metrics exceeds one of the plurality of performance thresholds. wherein the instructions further cause the device to: make the second NG a master NG after reporting the failure of the first NG.

Various embodiments are described, wherein the instructions after the shunt link is activated further cause the device to: collect second network gateway (NG) metrics for a first NG; analyze the second NG metrics to produce a plurality of second performance metrics; compare the plurality of second performance metrics to the plurality of performance thresholds; and deactivate the shunt link between the first NG and a second NG when all of the plurality of first performance metrics do not exceed any of the plurality of performance thresholds.

Various embodiments are described, wherein when the shunt link is deactivated the instructions further cause the device to: uninstall a flow rule on the first NG that sent packets received by the first NG from the network to the second NG; and make the first NG a master NG.

Further various embodiments relate to a method to reduce packet loss in a software defined network, including: collecting first network gateway (NG) metrics for a first NG, wherein the first NG receives data packets from a network; analyzing the first NG metrics to produce a plurality of first performance metrics; comparing the plurality of first performance metrics to a plurality of performance thresholds; and activating a shunt link between the first NG and a second NG when one of the plurality of first performance metrics exceeds one of the plurality of performance thresholds, wherein the shunt link transmits data packets received by the first NG from the network to the second NG.

Various embodiments are described, wherein the plurality of first performance metrics includes at least a compute metric and the plurality of performance thresholds includes at least a compute threshold.

Various embodiments are described, wherein the plurality of first performance metrics includes at least a network metric and the plurality of performance thresholds includes at least a network threshold.

Various embodiments are described, wherein the plurality of first performance metrics includes at least a control channel flap frequency metric and the plurality of performance thresholds includes at least a control channel threshold.

Various embodiments are described, wherein the plurality of first performance metrics includes a compute metric, a network metric, and a control channel flap frequency, and the plurality of performance thresholds includes a compute threshold, network threshold, and a control channel threshold.

Various embodiments are described, wherein activating the shunt link includes installing a flow rule on the first NG.

Various embodiments are described, further including: reporting a failure of the first NG to a SDN controller when one of the plurality of first performance metrics exceeds one of the plurality of performance thresholds.

Various embodiments are described, further including: making the second NG a master NG after reporting the failure of the first NG.

Various embodiments are described, further including: collecting second network gateway (NG) metrics for a first NG; analyzing the second NG metrics to produce a plurality of second performance metrics; comparing the plurality of second performance metrics to the plurality of performance thresholds; and deactivating the shunt link between the first NG and a second NG when all of the plurality of first performance metrics do not exceed any of the plurality of performance thresholds.

Various embodiments are described, further including when the shunt link is deactivated: uninstalling a flow rule on the first NG that sent packets received by the first NG from the network to the second NG; and making the first NG a master NG.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 illustrates a SDN architecture with a packet loss prevention controller.

FIG. 2 illustrates a shunt link between two NGs.

FIG. 3 illustrates the loss of packets after a network gateway failure.

FIG. 4 illustrates a flow chart of a shunt activation method.

FIG. 5 illustrates the preservation of packets after a network gateway failure.

FIG. 6 illustrates an exemplary hardware diagram for implementing the packet loss prevention controller, SDNC, or data layer in the SDN.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

A Software Defined Network (SDN) includes several redundant last-mile Network Gateways (NG) on access sites, to which the users logically connect, in order to access various services offered by the network. Whenever connectivity to a primary NG goes down, the Mastership (authority) gets handed over to a secondary NG, which then takes over as a Master Gateway. However, during the course of this handover, some of the in-transit packets continue to reach the primary NG and get dropped due to the failure of primary NG. Embodiments of systems and methods are disclosed that proactively detect a node/connectivity failure in NGs and prevent the loss of in-transit packets while the mastership handover is in progress. These embodiments reduce loss/delays in packet transmissions, thereby making networks highly reliable.

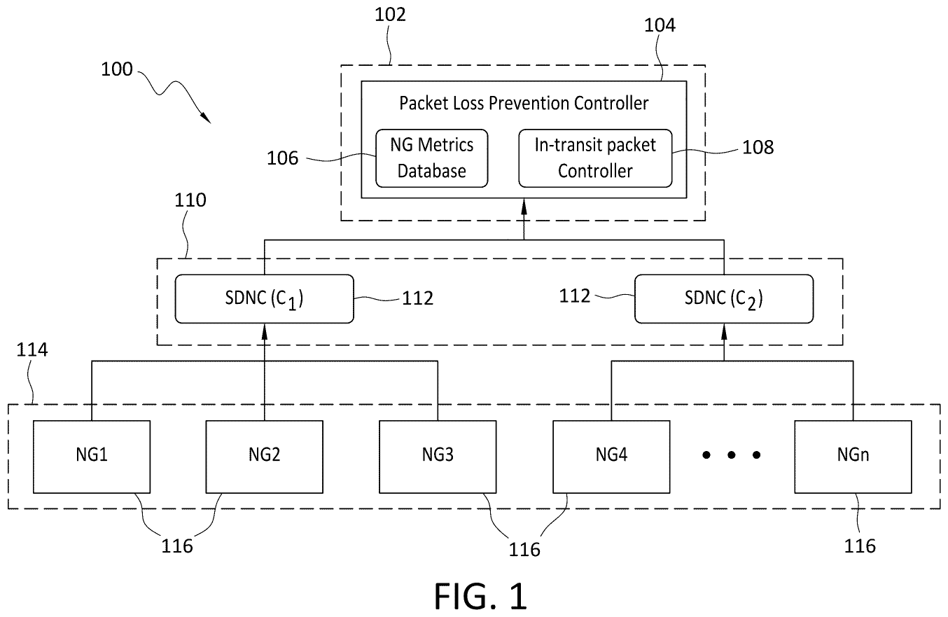

FIG. 1 illustrates a SDN architecture with a packet loss prevention controller. A SDN typically includes a Network Virtualization Overlay with one or more logically centralized controllers managing an IP-based underlay. In FIG. 1 the SDN 100 includes an application layer 102, a control layer 110, and a data layer 114. The application layer 102 is where applications reside and operate. In this specific example the application is a packet loss prevention controller 104 that will be described in further detail below, but the application layer 102 may include any applications needed in the SDN. The packet loss prevention controller 104 includes SDN controllers (SDNC) 112. In this example, two SDNCs are illustrated but fewer or more may be present. The data layer 114 includes a plurality of NGs 116. In this example there are n NGs 116. In large enterprise networks, the end devices (users) are logically connected to several NGs 116 to leverage the virtualized services offered by the network with the help of SDNCs 112.

In the SDN 100, in most cases, a NG, e.g., NG1, would be associated with a redundant NG, e.g., NG2. Due to the dynamic nature of networks, the nodes (including NGs) in a network are often susceptible to failures. When the connectivity to NG1 goes down, the mastership (or authority) gets handed over to NG2, and the users previously connected to NG1 will now be served by NG2 until the connectivity to NG1 is restored. During the process of Mastership handover to a secondary NG (NG2), some of the packets that are in transit to primary NG (NG1) get dropped due to NG1 going down. The packet transmission will go through successfully only once the Mastership handover is complete, and NG2 starts receiving packets from the network associated with NG1.

The severity of the loss of in-transit packets during the course of Mastership handover depends on the criticality of the packets. For example, if an NG is serving a mission-critical network, every packet needs to be timely delivered to the destination, and hence, in-transit packet loss could lead to serious consequences. If these packets are transmitted using the transmission control protocol (TCP), a retransmission mechanism would cause a delay in the packet delivery. In the case of the user datagram protocol (UDP) transmission, the lost in-transit packets will not be recovered/retransmitted.

Current SDN systems and methods lack a mechanism to proactively detect a failure in NGs in order to prevent the loss of in-transit packets during the course of mastership handover to secondary NGs. The future networks (5G and beyond) are expected to be highly reliable and self-healing, with ultra-low latency in packet transmissions, to provide an enhanced user experience. In order to meet these demands, there is a critical need to proactively prevent packet losses in SDNs, meet the service level agreements in 5G and beyond networks, and retain/enhance user experience.

The embodiments disclosed herein present methods to centrally collect network gateway metrics related to compute, network, and control channel flaps (i.e., performance metrics) by a NG metrics database 106 and store them for further analysis. The system also includes a central in-transit packet controller 108 for proactively preventing in-transit packet losses among NGs 116. The method carried out by the system includes analysis of NG metrics using various pre-defined thresholds and triggers the transfer of services accordingly. The methods also include activating a shunt link between the NGs to facilitate in-transit packet transmission, thereby preventing packet loss in the network.

In FIG. 1 NGs 116 (NG1, NG2, . . . NGn) in the SDN 100 are the last mile access gateways to which the users logically connect to access various services offered by the network. The SDNCs 112 are a centralized authority that manages, controls, and provisions the data plane with application layer services. The packet loss prevention controller 104 prevents the loss of in-transit packets transmitted during mastership handover among the NGs 116. The packet loss prevention controller 104 includes a NG metrics database 106 and in-transit packet controller 108. The NG metrics database 106 includes a database of network, compute, and control channel information of the NGs 116 in the network. These data points are collected at periodic intervals from the NGs 166 and updated in the database. The in-transit packet controller 108 evaluates the network, compute, and control channel metrics corresponding to each NG 116 in a redundant group from NG metrics database 106 and activates the shunt link in the NG 116 accordingly.

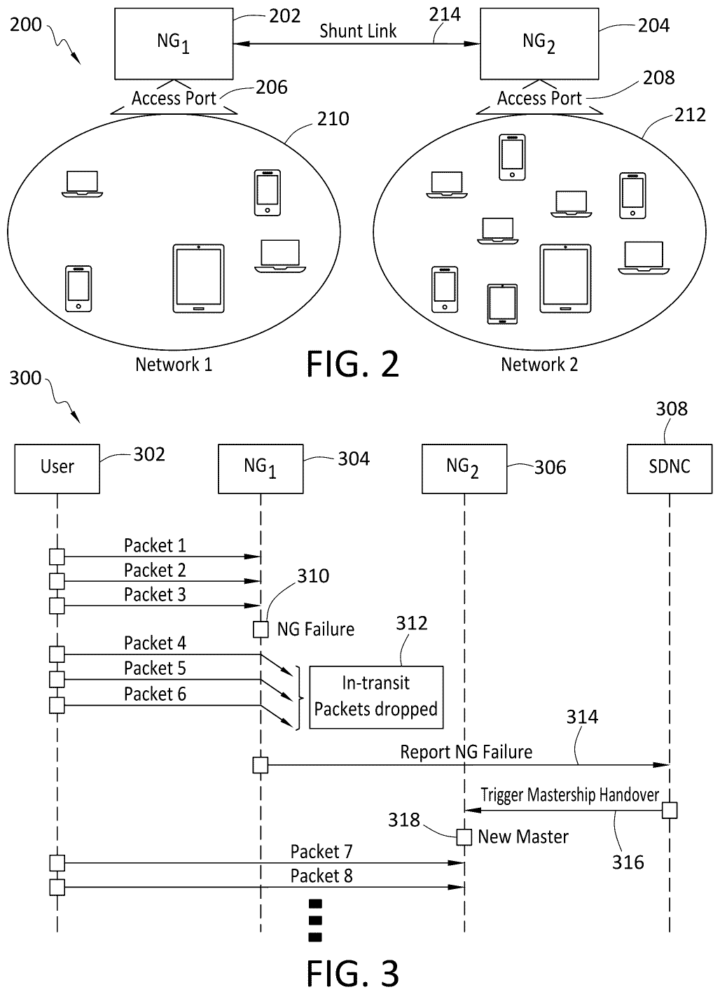

FIG. 2 illustrates a shunt link between two NGs. The redundant network 200 includes first NG 202 and second NG 204. A first network 210 connects to first NG 202 via a first access port 206. A second network 212 connects to second NG 204 via a second access port 208. The first NG 202 and second NG 204 are connected via shunt link 214.

In FIG. 2, NG1 202 and NG2 204 are primary and secondary network gateways respectively for the first network 210. If NG1 202 goes down, NG2 204 will take over the mastership, i.e., all packets from first network 210 will now be directly reaching second NG 204 for processing/forwarding.

Currently, during the course of mastership handover, the in-transit packets that continue to reach NG1 202 will be dropped. The SDN 100 implements a method to proactively detect the failure or coming failure of NG1 202 and forward the in-transit packets to NG2 204 via the shunt link 214 between NG1 202 and NG2 204. It is to be noted that NG2 204 also has its own network for which at it serves as a primary gateway. If NG2 204 goes down, a secondary gateway (either NG1 202 or some other gateway as configured) will take over the mastership.

The shunt link 214 is a physical or logical connection between the NGs. The shunt link 214 may be quickly activated, for example, by installing a flow rule in the NG that is failing to activate the shunt link 214.

In the scenario depicted in FIG. 2, NG1 continues to process the packets from first network 210 as long as it is up. Once a failure occurs in NG1, the mastership handover is initiated to NG2 with the help of the SDNC. During the course of this handover, the in-transit packets (Packet 4, Packet 5, Packet 6 as shown in FIG. 3 below) will get dropped due to the failure of NG1, and the handover still being in progress. In current systems, the packet transmission will be successful only after the mastership handover is complete.

FIG. 3 illustrates the loss of packets after a network gateway failure. The packet transmission sequence 300 between user 302, first NG 304, second NG 306, and SDNC 308 will now be described. The user 302 sends three packets 1-3 to the first NG 304. Then a NG failure 310 occurs. The user 302 next sends three packets 4-6 to the first NG 304. As a NG failure 310 at the first NG 304 has occurred, this results in dropped packets 312 where packets 4-6 are dropped. Next, a NG failure report 314 is sent to the SDNC 308. In response, the SDNC 308 triggers a mastership handover 316 that causes the second NG 306 to become the NG for the user 302. The user 302 then sends additional packets 7-9 to second NG 306. This may continue indefinitely, or the mastership may be transferred back to the first NG 304 by the SDNC 308 once the first NG 304 is back up and available.

The collection of NG metrics by NG metrics database 106 will now be described. In order to proactively detect a potential failure of a NG, the metrics identified below are collected in periodic intervals by the NG metrics database 106 and stored for further analysis to determine performance metrics for the NG.

Next, in-transit packet controller 108 computes performance metrics based upon the data in the 106. A failure of NG may very likely happen due to lack or overuse of compute resources allocated to the NG. This scenario may not lead to a complete node failure of the NG, however, the NG with the lack and/or overuse of compute resources may underperform or fail to provide an effective service. Hence, compute metrics are collected as part of the data collection. This is a set of compute resource-related parameters that may include, for example, CPU, memory remain, load, etc.

The in-transit packet controller 108 may also compute control channel metrics. An NG that faces constant/frequent flaps in its control channels (like Openflow, JSON-RPC, etc.) may not be an optimal NG to provide an effective service to end users. In this scenario, it is worthwhile to activate the shunt link 214 to hand over the service and packets to a neighboring redundant NG. Hence, control channel metrics (like uptime, latest flap, frequency of flaps, etc.) are collected as part of the data collection.

The in-transit packet controller 108 may also compute network metrics. An NG with congestion in its network (either due to increased user density or lack of network resources allocated to itself) may underperform in delivering network services, and hence a handover of services and packets by activating shunt link 214 is preferred in this scenario. The network metrics include bandwidth, latency, etc.

Once the NG metrics are collected in the database, the in-transit packet control block 108 analyses these metrics to generate performance metrics and based upon the performance metrics accordingly activates the shunt link 214 at the NG to hand over the packets and services to a redundant NG. The in-transit packet control block 108 may use the three thresholds described below to evaluate the NG performance metrics. These thresholds are pre-defined by the network administrator and are configurable. It is noted that these three performance metrics and related thresholds have been shown to be effective in predicting failure of NGs. It is noted that other performance metrics and thresholds may be used as well to determine when the NG has or is going to fail.

The compute threshold (Tc) relates to compute metrics. If the compute metrics (like CPU utilization, memory, load, etc.) of an NG increase beyond this threshold (Tc), then the shunt link 214 at this NG is activated by the in-transit packet controller 108.

The network threshold (Tn) relates to network metrics. A network congestion score collectively represents the network metrics (like bandwidth, latency etc.). The network congestion score may also be based on a single network metric. If this network congestion score of an NG increases beyond the network threshold (Tn), then the shunt link 214 at this NG is activated by the in-transit packet controller 108.

The control channel threshold (Tcc) relates to the frequency of control channel flaps. If the frequency of control channel flaps in a given interval increases beyond this threshold (Tcc), then the shunt link 214 at this NG is activated by the in-transit packet controller 108. It is noted that the frequency of control flaps may be for individual control signals or a group of control signals.

After the shunt link is activated, the packets and services of the impacted NG (say, NG1) are transferred to the redundant NG (NG2). Thereby, the in-transit packet controller 108 monitors the NG metrics in a periodic interval. If NG1 gets better in terms of compute, network, and control channel stability, the packets and services that were previously handled by NG1 are recovered by NG1 itself.

The Tc may be determined, for example, in the following way. The Tc may vary for different form factors of NGs. For instance, an NG with 64 cores/vCPUs can have a higher Tc compared to an NG with 4 cores/vCPUs. Hence, to generalize and set Tc for NGs of all form factors, historical NG crash reports (caused due to high compute metrics) can be analyzed. For example, for an NG, the sum average of each of the compute metrics values (of CPU utilization, memory %, load %) at which the NG crashed was observed, and these values can be set as the Tc

The Tcc may be determined, for example, in the following way. The NG control channels (typically OpenFlow, JSON-RPC) in deployed large enterprise networks mostly flap unexpectedly due to the dynamic nature of networks. There could be multiple reasons for a control channel flap in a network, including SDNC switchover, and NG reboot, among others. During a control channel flap, packet losses are expected until the mastership handover is complete. However, if NG flaps are frequent, especially within a short time interval, then the NG control channel flap is most likely to be consistent, leading to enormous packet loss. For instance, in one deployed network, the OpenFlow connection (between a particular NG and SDN Controller) flap was as frequent as one flap per minute. In this instance, data collected from the affected NG shows a total control channel flaps=19798. Hence, the Tcc may be set by the Network Administrator if the flap frequency goes beyond an unexpected value within a short interval of time. Based on the above experimental observations, this threshold can be set as 3 maximum permissible flaps in 5 minutes (or a similar proportion).

The Tn may be determined, for example, in the following way. Network congestion in a network could potentially deteriorate the user experience. To ensure the Service Level Agreements (SLA) in a network, it becomes critical to detect network congestion and accordingly activate shunt links to avoid packet loss, as described herein. Network congestion (in terms of bandwidth, latency, etc.) depends on the type of application/service consumed by the set of users. Once network congestion occurs in a network, the corresponding NG performances will go down, which ultimately gets recorded in the Performance Analytics or Telemetry data analytics. These log files can be analyzed by the Network Administrator to determine the levels/values of Network Metrics (bandwidth, latency, etc.) at the time of the network congestion. Such values can be set as the threshold Tn.

In an experimental SDWAN setup of 500 NGs, 4 SDNCs, and 1 Network Management Block, it was observed that the time required to activate a shunt link (by installing a necessary flow rule) between the NGs is around 10 milliseconds. On the other hand, the warning time before an NG fails/crashes is around 5 seconds. Given the significant difference between the warning time and the shunt activation time, there is sufficient scope for preventing in-transit packet loss using the methods proposed herein.

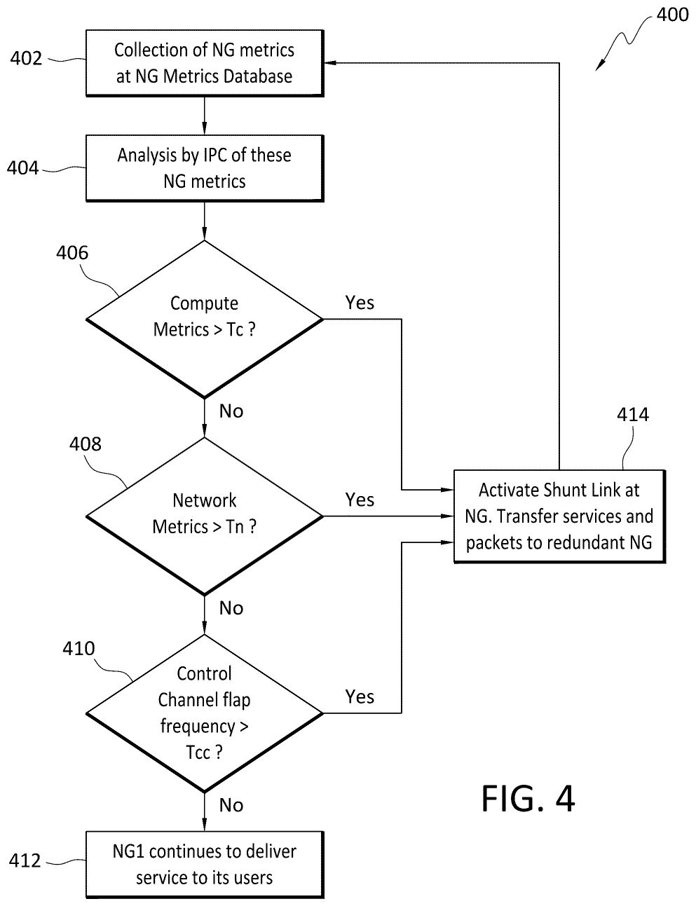

FIG. 4 illustrates a flow chart of a shunt activation method. The shunt activation method 400 begins with step 402 that includes the collection of NG metrics and the storge of the NG metrics in the NG metrics database 106. Next, the in-transit packet controller 108 at step 404 analyzes the NG metrics in the NG metrics database 106. Next, the shunt activation method 400 compares the compute metrics to compute threshold Tc at step 406. If the compute metrics exceed the compute threshold Tc, then the shunt activation method activates the shunt link and transfers services and packets to the redundant NG at step 414. If the compute metrics do not exceed the compute threshold Tc, then the shunt activation method 400 compares the network metrics to the network threshold Tn at step 408. If the network metrics exceed the compute threshold Tc, then the shunt activation method activates the shunt link and transfers services and packets to the redundant NG 414. If the network metrics do not exceed the compute threshold Tc, then the shunt activation method 400 compares the control channel flap frequency to the control channel threshold Tcc. If the control channel flap frequency exceed the control channel threshold Tcc, then the shunt activation method activates the shunt link and transfers services and packets to the redundant NG at step 414. If the compute metrics do not exceed the compute threshold Tc, then the primary NG continues to deliver service to its users at step 412.

The activation of the shunt link 214 by the in-transit packet controller 108 is performed by inserting a flow rule at the impacted first NG 202 to forward all packets reaching first NG 202 from the first network 210 to the redundant second NG 204 via the shunt link 214.

In this way, the in-transit packets sent to NG1 202 as described above in FIG. 3 get forwarded to NG2 204 during the course of mastership handover and reach the destination successfully. Once the mastership handover is complete and NG2 204 takes the authority, all packets from first network 210 directly reach second NG 204 without going through NG1 202. Hence, in-transit packet controller 108 deactivates the shunt link 214 and deletes the flow rule installed in NG1 202.

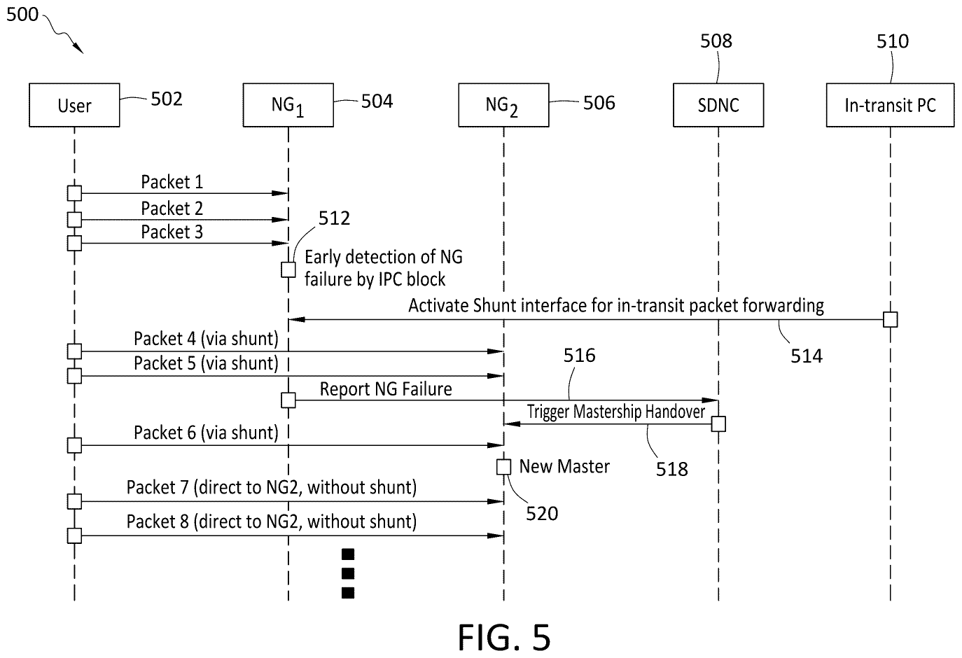

FIG. 5. illustrates the preservation of packets after a network gateway failure. The packet transmission sequence 500 between user 502, first NG 504, second NG 506, SDNC 508, and in-transit PC 510 will now be described. The user 502 sends three packets 1-3 to the first NG 504. Then the in-transit packet controller (PC) 510 detects an early NG failure 512 for example as described in the shunt activation method of FIG. 4. The in-transit PC 510 sends a message 514 to the first NG 504 to activate the shunt link 214 between first NG 504 and second NG 506. The user 502 next sends two packets 4-5 to first NG 504, first NG 504 forwards these packets to second NG 506 via shunt link 214. Next, a NG failure report 516 is sent to the SDNC 508. In response, the SDNC 508 triggers a mastership handover at 518 that causes the second NG 506 to become the NG for the user 502. About this same time, the user 502 then sends additional packet 6 to second NG 506 via first NG 504 and shunt link 214. Then the second NG 506 is established as the new master second NG at 520. Next, the user 502 sends two packets 7-8 to second NG 506. This may continue indefinitely, or the mastership may be transferred back to the first NG 504 by the SDNC 508 once the first NG 504 is back up and available. This may be done by repeating the steps 402, 404, 408, 410 for first NG 504 to determine if the first NG 504 has become available. Otherwise, the SDNC 508 may have mechanisms to determine that first NG 504 is available again. Then the shunt link may be deactivated and the mastership transfer from second NG 506 back to first NG 504. The shunt link may be deactivated by uninstalling a flow rule that was used to activated the shunt link.

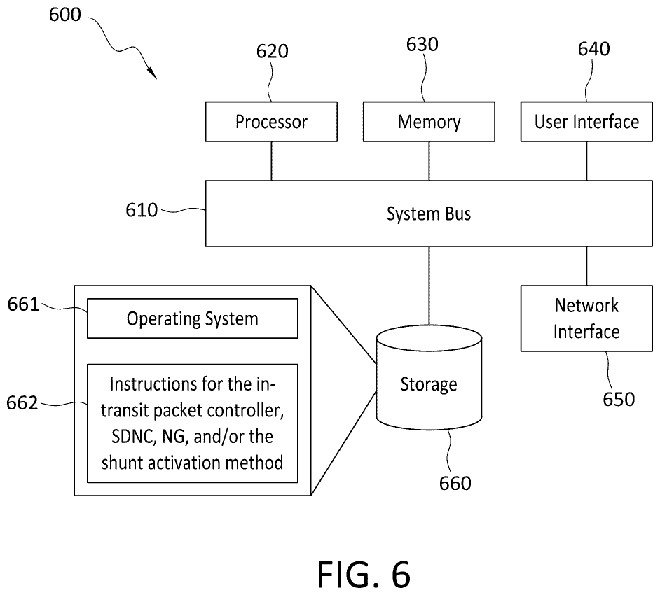

FIG. 6 illustrates an exemplary hardware diagram 600 for implementing the packet loss prevention controller 104, SDNC 112, or data layer 114 in the SDN 100. As shown, the device 600 includes a processor 620, memory 630, user interface 640, network interface 650, and storage 660 interconnected via one or more system buses 610. It will be understood that FIG. 6 constitutes, in some respects, an abstraction and that the actual organization of the components of the device 600 may be more complex than illustrated.

The processor 620 may be any hardware device capable of executing instructions stored in memory 630 or storage 660 or otherwise processing data. As such, the processor may include a microprocessor, microcontroller, graphics processing unit (GPU), neural network processor, field programmable gate array (FPGA), application-specific integrated circuit (ASIC), or other similar devices. The processor may be a secure processor or include a secure processing portion or core that resists tampering.

The memory 630 may include various memories such as, for example L1, L2, or L3 cache or system memory. As such, the memory 630 may include static random-access memory (SRAM), dynamic RAM (DRAM), flash memory, read only memory (ROM), or other similar memory devices. Further, some portion or all of the memory may be secure memory with limited authorized access and that is tamper resistant.

The user interface 640 may include one or more devices for enabling communication with a user such as an administrator. For example, the user interface 640 may include a display, a touch interface, a mouse, and/or a keyboard for receiving user commands. In some embodiments, the user interface 640 may include a command line interface or graphical user interface that may be presented to a remote terminal via the network interface 650.

The network interface 650 may include one or more devices for enabling communication with other hardware devices. For example, the network interface 650 may include a network interface card (NIC) configured to communicate according to the Ethernet protocol or other communications protocols, including wireless protocols. Additionally, the network interface 650 may implement a TCP/IP stack for communication according to the TCP/IP protocols. Various alternative or additional hardware or configurations for the network interface 650 will be apparent.

The storage 660 may include one or more machine-readable storage media such as read-only memory (ROM), random-access memory (RAM), magnetic disk storage media, optical storage media, flash-memory devices, or similar storage media. In various embodiments, the storage 660 may store instructions for execution by the processor 620 or data upon with the processor 620 may operate. For example, the storage 660 may store a base operating system 661 for controlling various basic operations of the hardware 600. The storage 662 may store instructions for carrying out the functions of in-transit packet controller 108, SDNC 112, and NG 116. It also may include instructions for carrying out the shunt activation method 400.

It will be apparent that various information described as stored in the storage 660 may be additionally or alternatively stored in the memory 630. In this respect, the memory 630 may also be considered to constitute a “storage device” and the storage 660 may be considered a “memory.” Various other arrangements will be apparent. Further, the memory 630 and storage 660 may both be considered to be “non-transitory machine-readable media.” As used herein, the term “non-transitory” will be understood to exclude transitory signals but to include all forms of storage, including both volatile and non-volatile memories.

The system bus 610 allows communication between the processor 620, memory 630, user interface 640, storage 660, and network interface 650.

While the host device 600 is shown as including one of each described component, the various components may be duplicated in various embodiments. For example, the processor 620 may include multiple microprocessors that are configured to independently execute the methods described herein or are configured to perform steps or subroutines of the methods described herein such that the multiple processors cooperate to achieve the functionality described herein. Further, where the device 600 is implemented in a cloud computing system, the various hardware components may belong to separate physical systems. For example, the processor 620 may include a first processor in a first server and a second processor in a second server.

The foregoing disclosure provides illustration and description but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code-it being understood that software and hardware can be designed to implement the systems and/or methods based, at least in part, on the description herein.

As used herein, the term “non-transitory machine-readable storage medium” will be understood to exclude a transitory propagation signal but to include all forms of volatile and non-volatile memory. When software is implemented on a processor, the combination of software and processor becomes a specific dedicated machine.

Because the data processing implementing the embodiments described herein is, for the most part, composed of electronic components and circuits known to those skilled in the art, circuit details will not be explained in any greater extent than that considered necessary as illustrated above, for the understanding and appreciation of the underlying concepts of the aspects described herein and in order not to obfuscate or distract from the teachings of the aspects described herein.

Unless stated otherwise, terms such as “first” and “second” are used to arbitrarily distinguish between the elements such terms describe. Thus, these terms are not necessarily intended to indicate temporal or other prioritization of such elements.

It should be appreciated by those skilled in the art that any block diagrams herein represent conceptual views of illustrative hardware embodying the principles of the aspects.

While each of the embodiments are described above in terms of their structural arrangements, it should be appreciated that the aspects also cover the associated methods of using the embodiments described above.

Unless otherwise indicated, all numbers expressing parameter values and so forth used in the specification and claims are to be understood as being modified in all instances by the term “about.” Accordingly, unless indicated to the contrary, the numerical parameters set forth in this specification and attached claims are approximations that may vary depending upon the desired properties sought to be obtained by embodiments of the present disclosure. As used herein, “about” may be understood by persons of ordinary skill in the art and can vary to some extent depending upon the context in which it is used. If there are uses of the term which are not clear to persons of ordinary skill in the art, given the context in which it is used, “about” may mean up to plus or minus 10% of the particular term.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A packet loss prevention controller in a software defined network, comprising:
at least one processor; and
at least one memory storing instructions, that when executed by the at least one processor, cause the device at least to:
collect first network gateway (NG) metrics for a first NG, wherein the first NG receives data packets from a network;
analyze the first NG metrics to produce a plurality of first performance metrics;
compare the plurality of first performance metrics to a plurality of performance thresholds; and
activate a shunt link between the first NG and a second NG when one of the plurality of first performance metrics exceeds one of the plurality of performance thresholds, wherein the shunt link transmits data packets received by the first NG from the network to the second NG.

2. The packet loss prevention controller of claim 1, wherein the plurality of first performance metrics includes at least a compute metric and the plurality of performance thresholds includes at least a compute threshold.

3. The packet loss prevention controller of claim 1, wherein the plurality of first performance metrics includes at least a network metric and the plurality of performance thresholds includes at least a network threshold.

4. The packet loss prevention controller of claim 1, wherein the plurality of first performance metrics includes at least a control channel flap frequency metric and the plurality of performance thresholds includes at least a control channel threshold.

5. The packet loss prevention controller of claim 1, wherein
the plurality of first performance metrics includes a compute metric, a network metric, and a control channel flap frequency, and
the plurality of performance thresholds includes a compute threshold, network threshold, and a control channel threshold.

6. The packet loss prevention controller of claim 1, wherein activating the shunt link includes installing a flow rule on the first NG.

7. The packet loss prevention controller of claim 1, wherein the instructions further cause the device to:
report a failure of the first NG to a SDN controller when one of the plurality of first performance metrics exceeds one of the plurality of performance thresholds.

8. The packet loss prevention controller of claim 7, wherein the instructions further cause the device to:
make the second NG a master NG after reporting the failure of the first NG.

9. The packet loss prevention controller of claim 1, wherein the instructions after the shunt link is activated further cause the device to:
collect second network gateway (NG) metrics for a first NG;
analyze the second NG metrics to produce a plurality of second performance metrics;
compare the plurality of second performance metrics to the plurality of performance thresholds; and
deactivate the shunt link between the first NG and a second NG when all of the plurality of first performance metrics do not exceed any of the plurality of performance thresholds.

10. The packet loss prevention controller of claim 9, wherein when the shunt link is deactivated the instructions further cause the device to:
uninstall a flow rule on the first NG that sent packets received by the first NG from the network to the second NG; and
make the first NG a master NG.

11. A method to reduce packet loss in a software defined network, comprising:
collecting first network gateway (NG) metrics for a first NG, wherein the first NG receives data packets from a network;
analyzing the first NG metrics to produce a plurality of first performance metrics;
comparing the plurality of first performance metrics to a plurality of performance thresholds; and
activating a shunt link between the first NG and a second NG when one of the plurality of first performance metrics exceeds one of the plurality of performance thresholds, wherein the shunt link transmits data packets received by the first NG from the network to the second NG.

12. The method of claim 11, wherein the plurality of first performance metrics includes at least a compute metric and the plurality of performance thresholds includes at least a compute threshold.

13. The method of claim 11, wherein the plurality of first performance metrics includes at least a network metric and the plurality of performance thresholds includes at least a network threshold.

14. The method of claim 11, wherein the plurality of first performance metrics includes at least a control channel flap frequency metric and the plurality of performance thresholds includes at least a control channel threshold.

15. The method of claim 11, wherein
the plurality of first performance metrics includes a compute metric, a network metric, and a control channel flap frequency, and
the plurality of performance thresholds includes a compute threshold, network threshold, and a control channel threshold.

16. The method of claim 11, wherein activating the shunt link includes installing a flow rule on the first NG.

17. The method of claim 11, further comprising:
reporting a failure of the first NG to a SDN controller when one of the plurality of first performance metrics exceeds one of the plurality of performance thresholds.

18. The method of claim 17, further comprising:
making the second NG a master NG after reporting the failure of the first NG.

19. The method of claim 11, further comprising:
collecting second network gateway (NG) metrics for a first NG;
analyzing the second NG metrics to produce a plurality of second performance metrics;
comparing the plurality of second performance metrics to the plurality of performance thresholds; and
deactivating the shunt link between the first NG and a second NG when all of the plurality of first performance metrics do not exceed any of the plurality of performance thresholds.

20. The method of claim 19, further comprising when the shunt link is deactivated:
uninstalling a flow rule on the first NG that sent packets received by the first NG from the network to the second NG; and
making the first NG a master NG.
